(19) United States
(12) Patent Application Publication
(10) Pub. No.: US 2013/0123981 A1
(43) Pub. Date: May 16, 2013

(54) SWARM INTELLIGENCE ROUTING ROBOT DEVICE AND MOVEMENT PATH CONTROL SYSTEM USING THE SAME

(71) Applicant: Electronics and Telecommunications Research In, Daejeon (KR)

(72) Inventors: Chang Eun LEE, Daejeon (KR); Young-Jo CHO, Daejeon (KR); Sung Hoon KIM, Daejeon (KR)

(73) Assignee: Electronics and Telecommunications Research Institute, Daejeon (KR)

(21) Appl. No.: 13/652,738

(22) Filed: Oct. 16, 2012

(30) Foreign Application Priority Data
Nov. 10, 2011 (KR) 10-2011-0116968

(51) Int. Cl. B25J 9/16

(52) U.S. Cl. 700/248; 901/1

(57) ABSTRACT

A swarm intelligence routing robot device includes wherein multiple swarm intelligence robot devices configure a cluster, and the swarm intelligence routing robot device configures and manages a wireless communication network to relay communication between the swarm intelligence robot devices which move in an atypical environment in the cluster, and selects a location thereof in order to maintain a communication state with the swarm intelligence robot devices with which the swarm intelligence routing robot device wants to establish a connection based on a network resource information management of the swarm intelligence robot devices.

### CROSS-REFERENCE TO RELATED APPLICATION(S)

The present invention claims priority of Korean Patent Application No. 10-2011-0116968, filed on Nov. 10, 2011, which is incorporated herein by reference.

### FIELD OF THE INVENTION

The present invention relates to a swarm intelligence routing robot device, and more particularly, to a swarm intelligence routing robot device for providing seamless real time connectivity of swarm intelligence robots and a system for a movement path control of the swarm intelligence robots using the same.

### BACKGROUND OF THE INVENTION

FIG. 1 is a view illustrating the configuration of a network including an apparatus for controlling a movement path of swarm intelligent robot group in accordance with the related art.

A swarm intelligence robot group 10 includes one or more master robots 11 and multiple slave robots 12. The master robot 11 and the slave robots 12 are connected to one or more adjacent robots by an elastic member 13.

The slave robots 12 are controlled by the master robot 11, and the master robot 11 is controlled by a movement path control device 20 that controls a movement path along which the swarm intelligence robot group 10 moves to a destination.

The movement path control device 20 includes a client unit 21 and a central controller 22. The client unit 21 receives destination information regarding a destination to which the swarm intelligence robot group 10 wants to move, from a user. The central controller 22 computes a motion equation of the swarm intelligence robot group 10 based on the destination information received from the client unit 21 and damper impedance of the elastic member 13, and then transmits the computation results to the master robot 11 so that the movement path of the swarm intelligence robot group 10 can be controlled by the master robot 11.

According to the related art, all the movement paths of the swarm intelligence robot group 10 are calculated through a real time motion equation computation, and all the slave robots 12 are controlled by the master robot 11.

Thus, the movement path computation algorithm is complicated to cause a load in a process of performing the computation algorithm, and a great amount of time is required to control a path of a robot due to a complicated real time computation algorithm resulting from an exceptional situation such as avoidance of an obstacle, a mutual collision between swarm intelligence robots, or the like. In addition, when a swarm intelligence robot moves to a target point outside a valid range of propagation, the swarm intelligence robot may break away or be separated from the swarm intelligence robot group.

### SUMMARY OF THE INVENTION

In view of the above, the present invention provides a technique of automatically configuring a wireless communication network in order to relay communication between swarm robots that move in an atypical environment, manage network resource information of the swarm robots, and appropriately controlling a location of a routing robot such that an optimal communication state can be maintained between the swarm robots.

In accordance with a first aspect of the present invention, there is provided a swarm intelligence routing robot device, wherein multiple swarm intelligence robot devices configure a cluster, and the swarm intelligence routing robot device configures and manages a wireless communication network to relay communication between the swarm intelligence robot devices which move in an atypical environment in the cluster, and selects a location thereof in order to maintain a communication state with the swarm intelligence robot devices with which the swarm intelligence routing robot device wants to establish a connection based on a network resource information management of the swarm intelligence robot devices.

In the embodiment, the swarm intelligence routing robot device, comprising: a network management unit for performing a network configuration management function and a network resource information management function in a middleware layer positioned between a message layer and a service layer above a network layer.

In the embodiment, the swarm intelligence routing robot device, wherein the network management unit includes: a network configuration manager for automatically configuring the wireless communication network; a topology manager for collectively managing network information of the swarm intelligence robot devices; a position manager for obtaining relative coordinates by using absolute coordinate information of the swarm intelligence robot devices and information regarding a distance between robots; a traffic manager for allocating or redistributing channels such that channels are not be overloaded, while monitoring traffic in the wireless communication network; and a resource manager for analyzing resource information of the swarm intelligence robot devices collected through the network configuration manager.

In the embodiment, the swarm intelligence routing robot device, wherein the network configuration manager registers information regarding the automatically configured swarm intelligence robot device, and collects and manages network information regarding state information and error information of the swarm intelligence robot device.

In the embodiment, the swarm intelligence routing robot device, wherein the network configuration manager provides an interface for interworking with a higher group, and obtains and discriminates events of a lower group. In the embodiment, the swarm intelligence routing robot device, wherein the topology manager manages a topology and routing table.

In the embodiment, the swarm intelligence routing robot device, wherein the topology manager manages processes an event and message in relation to grouping through a coalition management function, and manages information regarding group formation and secession.

In the embodiment, the swarm intelligence routing robot device, wherein the topology manager manages provides an interface for providing topology and coalition information to a higher application service group.

In the embodiment, the swarm intelligence routing robot device, wherein the position manager has a function of discriminating validity of location information and repairing the same in real time.

In the embodiment, the swarm intelligence routing robot device, wherein the position manager monitors an accidental situation including a collision by monitoring the entire locations.

In the embodiment, the swarm intelligence routing robot device, wherein the position manager provides a location and state of the swarm intelligence routing robot device in real time to an application service group.

In the embodiment, the swarm intelligence routing robot device, wherein the traffic manager limits types and amounts of data to be transmitted and changes a transmission period, in consideration of an amount of load of the entire channels.

In the embodiment, the swarm intelligence routing robot device, wherein the resource manager defines a role and function of each of the swarm intelligence routing robot devices.

In the embodiment, the swarm intelligence routing robot device, wherein the topology manager includes a topology configuration management group for administering a topology and routing table and a network path configuration, a coalition configuration management group for administering a group setting and cancellation, and a topology collector for performing a function of collecting real time node link information.

In the embodiment, the swarm intelligence routing robot device, wherein the coalition configuration management group includes a coalition event processor for handling message processing relating to a coalition configuration, and a coalition remaking for providing a management function regarding coalition reconfiguration, subscription, secession, generation, and extinction in consideration of network resources.

In accordance with a second aspect of the present invention, there is provided a system for controlling a movement path, comprising: multiple swarm intelligence robot devices for configuring at least two or more clusters and performing an assigned mission based on a cluster through cooperation; a swarm intelligence routing robot device for configuring and managing a wireless communication network to relay communication between the swarm intelligence robot devices which move in an atypical environment in the cluster, and selecting a location thereof to maintain a communication state with the swarm intelligence robot devices with which the swarm intelligence routing robot device wants to establish a connection based on a network resource information management of the swarm intelligence robot devices; and a mobile control device for controlling a movement path, while monitoring a state of the swarm intelligence robot devices through the swarm intelligence routing robot device.

In the embodiment, the system of claim 16, wherein when a connection of the wireless communication network between the swarm intelligence robot device and the mobile control device is cut off or when the connection is likely to be cut off, the swarm intelligence routing robot device moves between the swarm intelligence robot device and the mobile control device to maintain connectivity of the wireless communication network.

In the embodiment, the system of claim 16, wherein the swarm intelligence routing robot device configures the wireless communication network with a WLAN/WPAN-based ad-hoc network.

### BRIEF DESCRIPTION OF THE DRAWINGS

The above and other objects and features of the present invention will become apparent from the following description of embodiments, given in conjunction with the accompanying drawings, in which:

FIG. 1 is a view illustrating a network configuration including an apparatus for controlling a movement path of a swarm intelligence robot group in accordance with the related art;

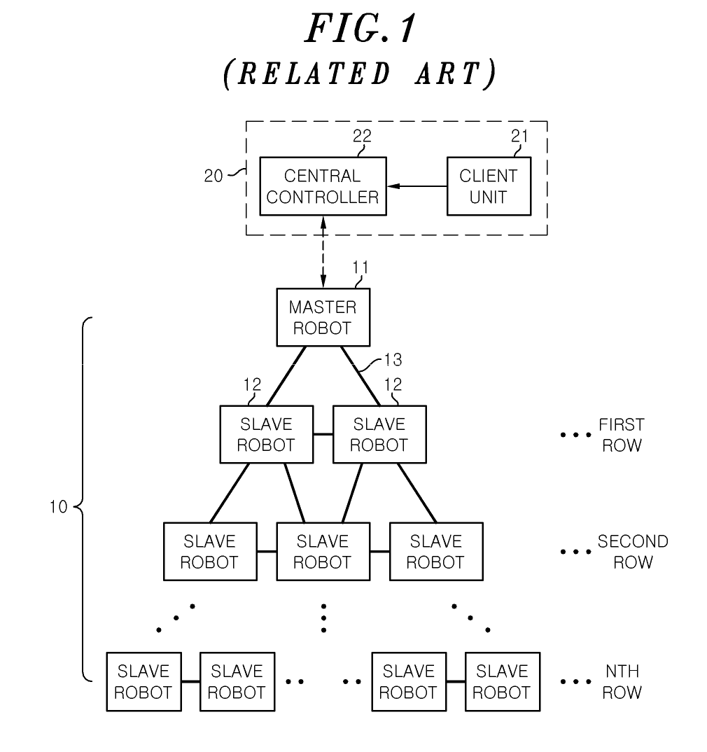

FIG. 2 is a view illustrating a network configuration including a system for controlling a movement path of a swarm intelligence robot group in accordance with an embodiment of the present invention;

FIG. 3 is a conceptual view illustrating a process of operating a swarm intelligence routing robot device in accordance with an embodiment of the present invention;

FIG. 4 is a view illustrating a detailed configuration of a network management unit included in the swarm intelligence routing robot device in accordance with an embodiment of the present invention;

FIG. 5 is a view illustrating an interworking function of a network configuration manager of the swarm intelligence routing robot device in accordance with an embodiment of the present invention; and

FIG. 6 is a view illustrating a detailed configuration of a topology manager of the swarm intelligence routing robot device in accordance with an embodiment of the present invention.

### DETAILED DESCRIPTION OF THE EMBODIMENTS

Embodiments of the present invention will be described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms need to be defined throughout the description of the present invention.

Combinations of each step in respective blocks of block diagrams and a sequence diagram attached herein may be carried out by computer program instructions. Since the computer program instructions may be loaded in processors of a general purpose computer, a special purpose computer, or other programmable data processing apparatus, the instructions, carried out by the processor of the computer or other programmable data processing apparatus, create devices for performing functions described in the respective blocks of the block diagrams or in the respective steps of the sequence diagram. Since the computer program instructions, in order to implement functions in specific manner, may be stored in a memory useable or readable by a computer aiming for a computer or other programmable data processing apparatus, the instruction stored in the memory useable or readable by a computer may produce manufacturing items including an instruction device for performing functions described in the respective blocks of the block diagrams and in the respective steps of the sequence diagram. Since the computer program instructions may be loaded in a computer or other programmable data processing apparatus, instructions, a series of processing steps of which is executed in a computer or other programmable data processing apparatus to create processes executed by a computer so as to operate a computer or other programmable data processing apparatus, may provide steps for executing functions described in the respective blocks of the block diagrams and the respective sequences of the sequence diagram.

Moreover, the respective blocks or the respective sequences may indicate modules, segments, or some of codes including at least one executable instruction for executing a specific logical function(s). In several alternative embodiments, is noticed that functions described in the blocks or the sequences may run out of order. For example, two successive blocks and sequences may be substantially executed simultaneously or often in reverse order according to corresponding functions.

Hereinafter, embodiments of the present invention will be described in detail with the accompanying drawings.

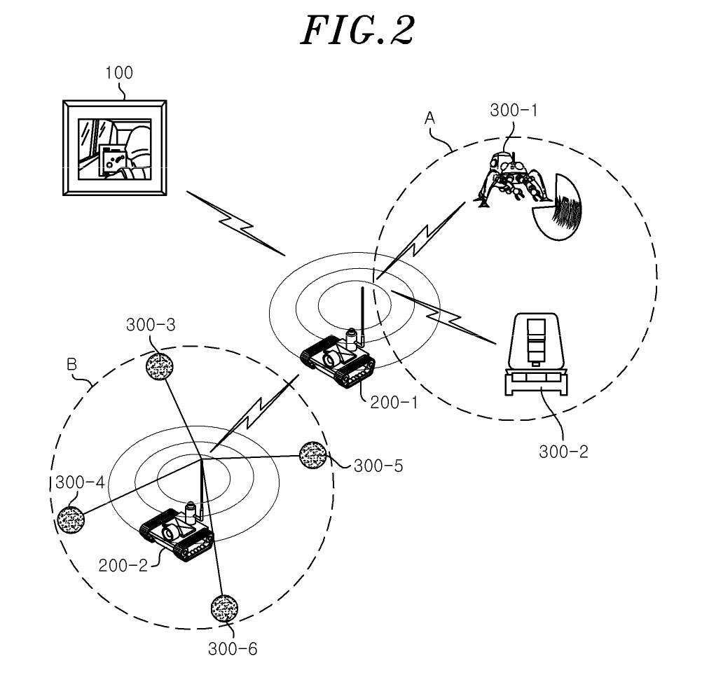

FIG. 2 is a view illustrating a network configuration including a system for controlling a movement path of a swarm intelligence robot group in accordance with an embodiment of the present invention.

A movement path control system in accordance with an embodiment of the present invention includes a mobile control device 100, swarm intelligence routing robot devices 200-1 and 200-2, swarm intelligence robot devices 300-1, 300-2, 300-3, 300-4, 300-5, and 300-6, and the like. Hereinafter, a reference numeral ‘200’ will be collectively used in a description with respect to all the swarm intelligence routing robot devices, and a reference numeral ‘300’ will be collectively used in a description with respect to all the swarm intelligence robot devices.

The swarm intelligence robot device 300 configures clusters A and B together with one or more different swarm intelligence robot devices, and performs an allocated mission based on cluster in cooperation with the different swarm intelligence robot devices.

The mobile control device 100 controls a movement path while monitoring a state of the swarm intelligence robot devices 300 through the swarm intelligence routing robot device 200.

The swarm intelligence routing robot device 200 configures and manages a wireless communication network by the swarm intelligence robot devices 300 within the clusters A and B. For example, the swarm intelligence routing robot device 200 may automatically configure a WPAN (Wireless Personal Area Network)/WLAN (Wireless Local Area Network)-based ad-hoc mesh network in order to relay communication between the swarm intelligence robot devices 300 moving in an atypical environment within a corresponding cluster. The swarm intelligence routing robot device 200 appropriately selects a location thereof such that network resource information of the swarm intelligence robot devices 300 and an optimal communication state can be maintained between the swarm intelligence robot devices 300, and serves to remotely enable the swarm intelligence robot devices 300 that perform a given mission in a shadow area to provide a seamless service.

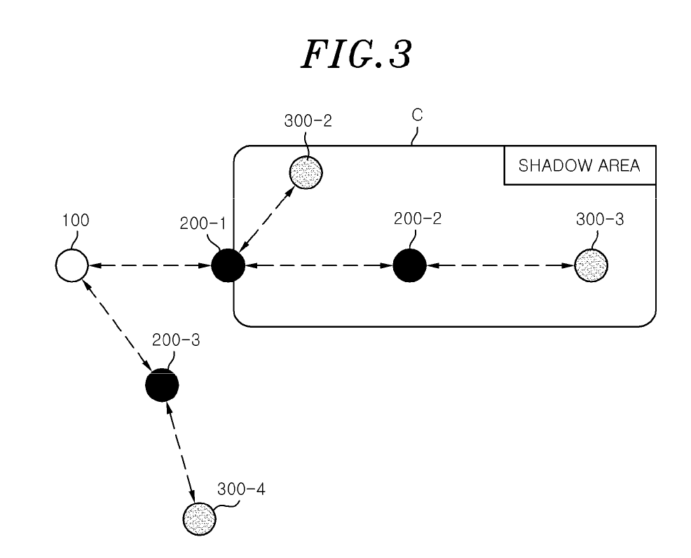

FIG. 3 is a conceptual view illustrating a process of operating a swarm intelligence routing robot device in accordance with an embodiment of the present invention.

A first swarm intelligence routing robot device 200-1 is introduced to maintain connectivity between the mobile control device 100 and the second swarm intelligence robot device 300-2 in a case where a network connection between the mobile control device and a second swarm intelligence robot device 300-2 and a third swarm intelligence robot device 300-3 is cut off or a network connection therebetween the is likely to be cut off as the second swarm intelligence robot device 300-2 and the third swarm intelligence robot device 300-3, which have been given a mission from the mobile control device 100, move to a shadow area C.

In addition, when the third swarm intelligence robot device 300-3 moves out of a valid propagation range of the first swarm intelligence routing robot device 200-1 or is likely to move out of the valid propagation range, another second swarm intelligence routing robot device 200-2 is newly introduced to support a seamless service between the third swarm intelligence robot device 300-3 and the mobile control device 100.

When a fourth swarm intelligence robot device 300-4 moves out of the valid propagation range from the mobile control device 100 or the fourth swarm intelligence robot device 300-4 is anticipated to move out of the valid propagation range, another third swarm intelligence routing robot device 300-3 is newly introduced to configure a WLAN/WPAN-based ad-hoc network in order to support a seamless connection between the mobile control device 100 and the fourth swarm intelligence robot device 300-4.

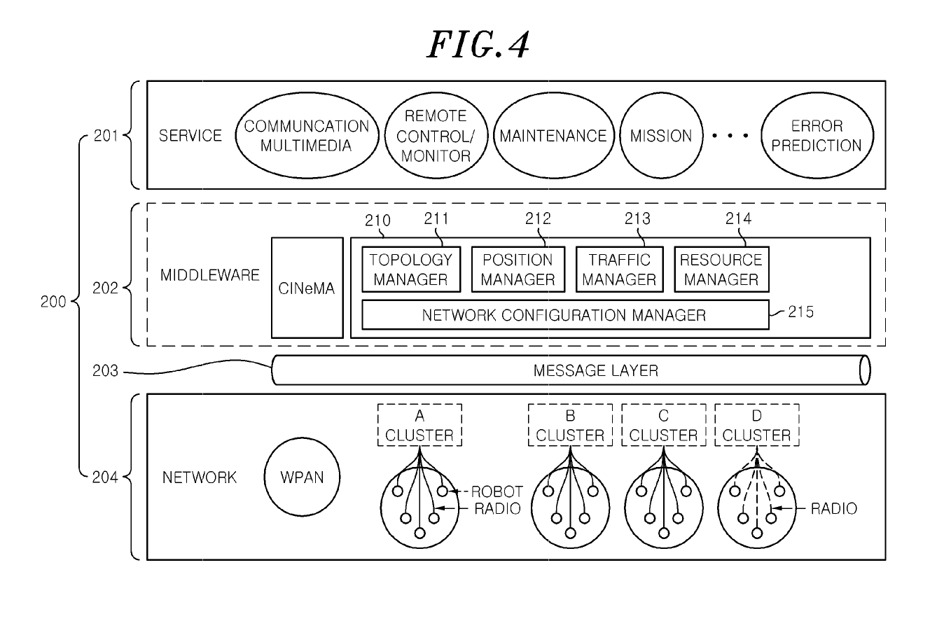

FIG. 4 is a view illustrating a detailed configuration of a network management unit included in the swarm intelligence routing robot device in accordance with an embodiment of the present invention. For example, as illustrated in FIG. 4, a network management unit 210 may be ported to a swarm intelligence routing robot device so as to be implemented as a software stack that supports a network routing operation, and a middleware layer 220 may perform a network configuration management function and a network resource information management function. Here, the swarm intelligence routing robot device 200 further includes a service layer 201, a message layer 203, and a network layer 204. The network configuration management function performed by the network management unit 210 refers to a dynamic ad-hoc mesh network configuration management and indoor/outdoor continuous positioning technique, and the network information management function refers to a network resource information management technique for supporting a robot application such as a remote controlling/monitoring or the like. Thus, a software stack corresponding to the network management unit 210 may be a collective intelligence network management architecture (CINeMA)

As illustrated in FIG. 4, the network management unit 210 may include a topology manager (TM) 211, a position manager (PM) 212, a traffic manager (TRM) 213, a resource manager (RM) 214, and a network configuration manager (NCM) 215.

The NCM 215 may automatically configure a network through a network connection management, a network ID allocation, a network security, and the like. In addition, the NCM 215 registers information regarding the automatically configured swarm intelligence robot device, and collects and manages network information regarding state information, error information and the like of the swarm intelligence robot device. Also, the NCM 215 provides an interface for interworking with a higher group, obtains/discriminates an event of a lower group, and delivers the same to a relevant manager.

The TM 211 collectively or integrally manages network information of swarm intelligence robots. For example, the TM 211 may manage network topology information and events transferred through the NCM 215. The TM 211 manages a topology and routing table and provides the shortest/optimal path for networking. Also, the TM 211 processes every event and message in relation to grouping through a coalition management function, and manages information regarding a group formation, secession and the like. This allows for a dynamic coalition configuration. The TM 211 provides an interface for providing topology and coalition information to a higher application service group.

The PM 212 obtains relative coordinates by using absolute coordinate information of a swarm intelligence robot device and information regarding a distance between robots, and calculates coordinates of every robot device cooperatively through a swarm intelligence robot network in real time. In this case, the PM 212 is provided with auxiliary information in order to quickly obtain absolute coordinates in an external shadow area. The PM 212 has a function of discriminating validity of location information and repairing it in real time, and monitors an accidental situation such as a collision or the like by monitoring the entire locations. The PM 212 provides a location and state of a swarm intelligence robot device in real time to the application service group so that a user can recognize it.

The TM 213 allocates or redistributes channels such that channels are not overloaded while monitoring traffic in a network in real time. Also, in consideration of the load amount of the entire channels, the TM 213 minimizes a load by limiting types and amounts of data to be transmitted and changing a transmission period.

The RM 214 analyzes resource information of a swarm intelligence robot device collected through the NCM 215, defines a role and function of each swarm intelligence robot device, and allows for an appropriate mission allocation and fast role replacement.

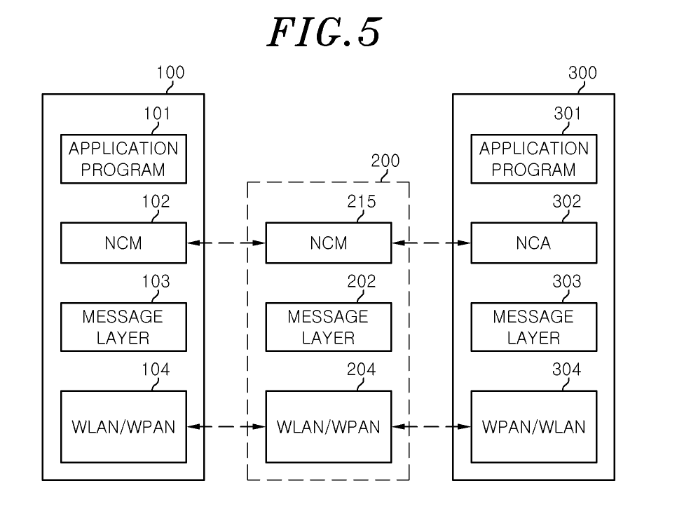

FIG. 5 is a view illustrating an interworking function of the network configuration manager 215 of the swarm intelligence routing robot device 200 in accordance with an embodiment of the present invention.

The mobile control device 100 in accordance with an embodiment of the present invention includes an NCM 102 disposed between an application program layer 101 and a message layer 103, and the swarm intelligence robot device 300 includes a network configuration agent (NCA) 302 disposed between an application program layer 301 and a message layer 303. In FIG. 5, reference numeral 104 denotes a network layer of the mobile control device 100, and reference numeral 304 denotes a network layer of the swarm intelligence robot device 300.

Among them, the NCMs 102 and 215 handle automatic network configuration and information management of the swarm intelligence routing robot device 200 and the mobile control device 100 and the NCA 302 handles automatic network configuration and information management of the swarm intelligence robot devices 300. The NCMs 102 and 215 and the NCA 302 may be called a network configuration manager architecture (NCMA).

The NCMs 102 and 215 and the NCA 302 may interwork to perform automatic network configuration management, a network data management, and a network information management.

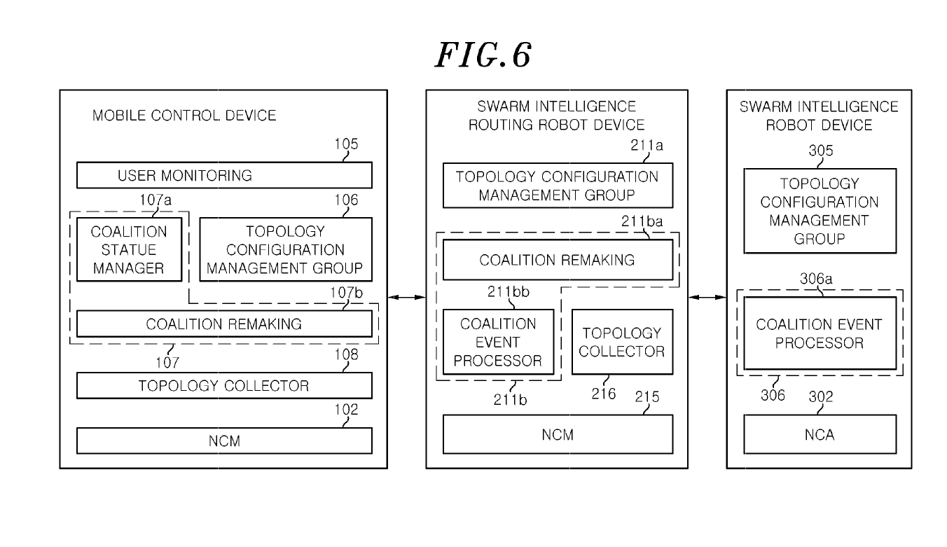

The automatic network configuration management includes a network connection management (advertisement, discovery, etc.), a network ID assignment, and network security (security & authentication), and the network data management includes functions related to robot events (event detection & occurrence, message relay, event subscription/un-subscription, event table management, etc.). The network information management includes network information registration and collection, a robot state management (life cycle management, performance state management), and an error management (fault diagnosis/recovery/report, device aliveness check). FIG. 6 is a view illustrating a detailed configuration of the topology manager 211 of the swarm intelligence routing robot device in accordance with an embodiment of the present invention.

The TM 211 includes a topology configuration management group 211a for administering a topology and routing table and a network path configuration, and a coalition configuration management group 211b for administering a group setting and cancellation. Here, the coalition configuration management group 211b includes a coalition remaking block 211ba and a coalition event processor 211bb. The swarm intelligence routing robot device 200 further includes a topology collector 216.

The mobile control device 100 includes a user monitoring block 105, a topology configuration management group 106, a coalition configuration management group 107, and a topology collector 108. The coalition configuration management group 107 includes a coalition state manager 107a and a coalition remaking block 107b.

The swarm intelligence robot device 300 includes a topology configuration management group 305 and a coalition configuration management group 306. The coalition configuration management group 306 includes a coalition event processor 306a.

Among them, the coalition event processors 211bb and 306a handle processing of a message relating to a coalition configuration. For example, the coalition event processor 211bb receives and interprets a coalition-related message in real time, and delivers the same to the coalition remaking block 211ba.

In addition, the coalition remaking block 211ba provides a management function regarding coalition reconfiguration, subscription, secession, generation, and extinction in consideration of network resources, the coalition state manager 107a provides a real time monitoring function such as a coalition breakaway or the like, and the topology collectors 108 and 216 perform a function of collecting real time node link information.

In accordance with the embodiments of the present invention, a cluster-based dynamic ad-hoc mesh network of swarm intelligence robots is configured and managed, and network resource information such as a propagation strength, a propagation valid distance, propagation interference, a physical/logical network topology, a network link state, and the like is managed. A location of a swarm intelligence routing robot is controlled to maintain an optimal communication state with swarm intelligence robots with which a connection is intended to be established. Accordingly, real-time connectivity may be provided even to swarm intelligence robots located in a shadow area such as a tunnel, a drain pipe, underground facility or the like, which is outside of a valid propagation range.

Thus, various multi-cluster type swarm intelligence robot services capable of performing a given mission even in a shadow area can be provided, and can be widely applied to social safety, surveillance patrol, and fire protection sectors.

While the invention has been shown and described with respect to the embodiments, the present invention is not limited thereto. It will be understood by those skilled in the art that various changes and modifications may be made without departing from the scope of the invention as defined in the following claims.

What is claimed is:

1. A swarm intelligence routing robot device,
wherein multiple swarm intelligence robot devices configure a cluster, and
the swarm intelligence routing robot device configures and manages a wireless communication network to relay communication between the swarm intelligence robot devices which move in an atypical environment in the cluster, and selects a location thereof in order to maintain a communication state with the swarm intelligence robot devices with which the swarm intelligence routing robot device wants to establish a connection based on a network resource information management of the swarm intelligence robot devices.

2. The swarm intelligence routing robot device of claim 1, comprising:
a network management unit for performing a network configuration management function and a network resource information management function in a middleware layer positioned between a message layer and a service layer above a network layer.

3. The swarm intelligence routing robot device of claim 2, wherein the network management unit comprises:
a network configuration manager for automatically configuring the wireless communication network;
a topology manager for collectively managing network information of the swarm intelligence robot devices;
a position manager for obtaining relative coordinates by using absolute coordinate information of the swarm intelligence robot devices and information regarding a distance between robots;
a traffic manager for allocating or redistributing channels such that channels are not be overloaded, while monitoring traffic in the wireless communication network; and
a resource manager for analyzing resource information of the swarm intelligence robot devices collected through the network configuration manager.

4. The swarm intelligence routing robot device of claim 3, wherein the network configuration manager registers information regarding the automatically configured swarm intelligence robot device, and collects and manages network information regarding state information and error information of the swarm intelligence robot device.

5. The swarm intelligence routing robot device of claim 3, wherein the network configuration manager provides an interface for interworking with a higher group, and obtains and discriminates events of a lower group.

6. The swarm intelligence routing robot device of claim 3, wherein the topology manager manages a topology and routing table.

7. The swarm intelligence routing robot device of claim 3, wherein the topology manager manages processes an event and message in relation to grouping through a coalition management function, and manages information regarding group formation and secession.

8. The swarm intelligence routing robot device of claim 3, wherein the topology manager manages provides an interface for providing topology and coalition information to a higher application service group.

9. The swarm intelligence routing robot device of claim 3, wherein the position manager has a function of discriminating validity of location information and repairing the same in real time.

10. The swarm intelligence routing robot device of claim 3, wherein the position manager monitors an accidental situation including a collision by monitoring the entire locations.

11. The swarm intelligence routing robot device of claim 3, wherein the position manager provides a location and state of the swarm intelligence routing robot device in real time to an application service group.

12. The swarm intelligence routing robot device of claim 3, wherein the traffic manager limits types and amounts of data to be transmitted and changes a transmission period, in consideration of an amount of load of the entire channels.

13. The swarm intelligence routing robot device of claim 3, wherein the resource manager defines a role and function of each of the swarm intelligence routing robot devices.

14. The swarm intelligence routing robot device of claim 3, wherein the topology manager comprises:
a topology configuration management group for administering a topology and routing table and a network path configuration;
a coalition configuration management group for administering a group setting and cancellation; and
a topology collector for performing a function of collecting real time node link information.

15. The swarm intelligence routing robot device of claim 14, wherein the coalition configuration management group comprises a coalition event processor for handling message processing relating to a coalition configuration, and a coalition remaking for providing a management function regarding coalition reconfiguration, subscription, secession, generation, and extinction in consideration of network resources.

16. A system for controlling a movement path, comprising:
multiple swarm intelligence robot devices for configuring at least two or more clusters and performing an assigned mission based on a cluster through cooperation;
a swarm intelligence routing robot device for configuring and managing a wireless communication network to relay communication between the swarm intelligence robot devices which move in an atypical environment in the cluster, and selecting a location thereof to maintain a communication state with the swarm intelligence robot devices with which the swarm intelligence routing robot device wants to establish a connection based on a network resource information management of the swarm intelligence robot devices; and
a mobile control device for controlling a movement path, while monitoring a state of the swarm intelligence robot devices through the swarm intelligence routing robot device.

17. The system of claim 16, wherein the swarm intelligence routing robot device moves between the swarm intelligence robot device and the mobile control device to maintain connectivity of the wireless communication network when a connection of the wireless communication network between the swarm intelligence robot device and the mobile control device is cut off or when the connection is likely to be cut off.

18. The system of claim 16, wherein the swarm intelligence routing robot device configures the wireless communication network with a WLAN (Wireless Local Area Network)/WPAN (Wireless Personal Area Network)-based ad-hoc network.
